(19) United States
(12) Patent Application Publication
(10) Pub. No.: US 2024/0419551 A1
(43) Pub. Date: Dec. 19, 2024

(54) ARCHITECTURAL REDUCTION OF VOLTAGE AND CLOCK ATTACK WINDOWS

(71) Applicant: Akeana, Inc., San Jose, CA (US)

(72) Inventor: Rabin Sugumar, Sunnyvale, CA (US)

(73) Assignee: Akeana, Inc., San Jose, CA (US)

(21) Appl. No.: 18/666,884

(22) Filed: May 17, 2024

Related U.S. Application Data
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/471,283, filed on Jun. 6, 2023.
(60) Provisional application No. 63/467,335, filed on May 18, 2023.
(60) Provisional application No. 63/640,921, filed on May 1, 2024.
(60) Provisional application No. 63/641,045, filed on May 1, 2024.

(51) Int. Cl. G06F 11/14; G06F 11/07

(52) U.S. Cl. CPC G06F 11/1405; G06F 11/076; G06F 11/0772

(57) ABSTRACT

Disclosed embodiments provide techniques for enhancing security of a processor. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce the functionality of the processor core. The reduced functionality includes halting the processor core, shutting down the processor core, switching the functionality of the processor core to a safe mode, and/or other suitable actions. The consistency unit can include a program counter comparison function. The consistency unit can include a completion signal check function. The consistency unit can include an address check function. The consistency unit can include a temporal proximity check function. Disclosed embodiments provide safeguards against various environmental attacks, such as voltage and/or clock alterations.

### RELATED APPLICATIONS

This application claims the benefit of U.S. provisional patent applications “Architectural Reduction Of Voltage And Clock Attack Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563,102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, and “Circular Queue Management With Nondestructive Speculative Reads” Ser. No. 63/641,045, filed May 1, 2024.

Each of the foregoing applications is hereby incorporated by reference in its entirety.

### FIELD OF ART

This application relates generally to computer processors and more particularly to an architectural reduction of voltage and clock attack windows.

### BACKGROUND

Nearly all aspects of modern life involve computers in some way. Computer processors are found in a wide variety of products such as smartphones, tablets, televisions, laptop computers, desktop computers, gaming consoles, automobiles, appliances, and more. Processors are used in almost every industry, from healthcare and finance to manufacturing and transportation. Processors also play a crucial role in home automation systems, which allow us to control various aspects of our homes through our smartphones or voice-activated devices. This includes controlling lights, thermostats, security systems, and other devices. Additionally, processors are used in modern cars to control everything from the engine and transmission to the infotainment system and safety features. Overall, processors have become essential components of modern life, powering many of the devices and systems that people rely on every day.

Main categories of processors include Complex Instruction Set Computer (CISC) types and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels of logic in detail. Behavioral level logic allows for a set of instructions to be executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool. The synthesis tool then creates the gate-level abstraction of the design that is used for downstream implementation operations.

The proliferation of computerized equipment, as stated previously, highlights the need for sufficient computer security at all levels of usage. Computer security is important as it protects all categories of data from theft and damage. This includes data such as personally identifiable information (PII), protected health information (PHI), financial information, and other sensitive data. Additionally, computer security protects vital infrastructure such as the electric grid, water supply, and other utilities. Furthermore, the rise in cloud services, smartphones, and the Internet of Things (IoT) has resulted in thousands of potential security vulnerabilities that did not exist a few decades ago.

### SUMMARY

Processors are ubiquitous, and are now found in everything from appliances to satellites. The processors enable the devices within which the processors are located to execute a wide variety of applications. The applications include telephony, messaging, data processing, patient monitoring, vehicle access and operation control, etc. The processors are coupled to additional elements that enable the processors to execute their assigned applications. The additional elements typically include one or more of shared, common memories, communication channels, peripherals, and so on. Because processors are now embedded in many everyday devices ranging from automobiles and smartphones to industrial and institutional infrastructure, protecting computers from malicious actions such as hacks is more important than ever before. There are various layers of computer security. Many layers involve software, such as operating systems, firewalls, antivirus software, and so on. Another aspect of computer security involves the hardware itself. There are various attacks that malicious actors may try in order to circumvent hardware security measures. One such type of attack includes an environmental attack. In an environmental attack, voltages and/or clocks are altered to be outside of the intended operating range, in order to get a processor to malfunction in a way that bypasses security measures. In a recent real-world example, hackers performed voltage manipulation during a boot sequence of a device, enabling read-protected data to be extracted. Although the attack may not work 100% of the time, hackers devise an FPGA-based retry mechanism to periodically retry the attack until the secure data can be accessed. If the secure data that gets revealed is a key, certificate, or other sensitive data, much more damage can be done. Thus, this example highlights the need for countermeasures at the hardware level to minimize voltage and clock attack windows, and to reduce the likelihood of success for malicious actors attempting these types of attacks.

Disclosed embodiments provide techniques for enhancing security of a processor. Multiple consistency units are distributed within a processor core. The consistency units can include, but are not limited to, a temporal proximity check, an address check, a completion signal check, and/or a PC comparison. Temporal proximity checks can utilize time windows to monitor a predetermined number of illegal instructions and/or illegal address exceptions. An address check function can compare a value associated with a store instruction to a memory address with a return value from a load instruction from the same memory address when the load instruction and store instruction are separated by a number of instructions. A completion signal check can verify a valid state of an instruction at the retire unit. A PC comparison can compare a completing program counter value with an expected program counter value. Instructions are executed in an architecturally defined mode. The architecturally defined mode can be based on an instruction set architecture (ISA), such as x86™, ARM™, MIPS™, RISC-V™, and/or other suitable instruction set architectures. In response to detecting an error in at least one consistency unit, disclosed embodiments reduce the functionality of the processor core. The reduced functionality can include halting the processor core, shutting down the processor core, switching the functionality of the processor core to a safe mode, and/or other suitable actions. In this way, disclosed embodiments provide additional safeguards against various environmental attacks, such as voltage and/or clock alterations.

A computer-implemented method for enhancing security is disclosed comprising: implementing a processor core, wherein the processor core includes semiconductor logic and one or more consistency units; distributing, within the processor core, the one or more consistency units; executing instructions, by the processor core, in an architecturally defined mode; detecting at least one error in the one or more consistency units that were distributed; and reducing a functionality of the processor core upon detection of the at least one error in the one or more consistency units. In embodiments, the one or more consistency units include a program counter comparison function. In embodiments, the program counter comparison function comprises comparing a completed program counter value with an expected program counter value. In embodiments, the one or more consistency units include a completion signal check function. In embodiments, the completion signal check function comprises comparing a completion signal associated with an instruction to a valid signal associated with the instruction in a dispatch unit. In embodiments, the one or more consistency units include an address check function. In embodiments, the address check function further comprises saving a store value associated with a store instruction to a memory address. Some embodiments comprise comparing the store value with a load return value from a load instruction associated with the memory address. In embodiments, the one or more consistency units include a temporal proximity check function.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for architectural reduction of voltage and clock attack windows.

FIG. 2 is a flow diagram for including consistency units.

FIG. 3 is a block diagram illustrating a multicore processor.

FIG. 4 is a block diagram for a pipeline.

FIG. 5 is a block diagram for a program counter comparison function.

FIG. 6 is a block diagram for a completion signal check function.

FIG. 7 is a block diagram for an address check function.

FIG. 8 is a system diagram for architectural reduction of voltage and clock attack windows.

### DETAILED DESCRIPTION

Malicious computer actors, sometimes referred to as “black hat” hackers, are relentless in their attempts to find vulnerabilities in hardware and software. The vulnerabilities, once exploited, can provide access to unauthorized data, accounts, and/or other computer resources. In the software realm, the hackers can relentlessly test ports for access, firewall misconfigurations, operating systems that have not been updated to the latest versions, and so on. In the hardware realm, the hackers can experiment with varying voltages and/or clock frequencies outside of their intended ranges, to see if they can get the hardware to malfunction in a way that reveals access to protected data or obtains some other behavior that is unintended and provides access to data and/or other resources that the hackers are not supposed to have.

Techniques for enhancing processor security are disclosed. Multiple consistency units are distributed throughout the processor core(s), and/or to other parts of an integrated circuit, such as a System on Chip (SoC). The consistency units can include circuits and/or modules for comparing and/or verifying proper operation at various stages/locations within an integrated circuit. The consistency units can check for correctness of various parameters, including, but not limited to, program counter values, instruction validity, and/or memory contents. The circuits within the consistency units can be designed and implemented to exceed the specified voltage and/or frequency limits of the integrated circuit. As an example, a chip such as an SoC may have a specified input voltage range of 3.2 volts to 3.4 volts, while the consistency check circuitry may be designed to function at an input voltage in the range from 1.0 volts to 9.5 volts. In this way, even if a majority of the chip is not functioning properly due to an out-of-range input voltage, the specific circuits and/or logic blocks that comprise consistency units are more likely to be operating within designed limits, and function properly to detect and mitigate such voltage attacks. A similar approach can be applied to clock frequencies. The hackers can try to overclock an integrated circuit (IC) such as an SoC. As an example, a processor can have a rated clock speed ranging from 3.5 GHz to 4.1 GHZ, while the consistency units may be rated to operate at a clock speed ranging from 90 MHz to 5 GHz. In this way, the consistency units are more likely to be operational, and thus able to detect improper results.

A logic gate signal voltage is a specific voltage level that determines the output of a logic gate. A logic gate is a fundamental building block of digital circuits and performs logical operations based on the input signals it receives. The signal voltage of a logic gate refers to the minimum voltage level required for the gate to recognize an input signal as either high or low. This signal voltage is typically fixed and determined by the specific type of logic gate. For example, in a typical TTL (transistor-transistor logic) gate, the signal voltage for a high input is around 2 volts, while the signal voltage for a low input is around 0.8 volts. If the input voltage is above the high signal voltage, the gate recognizes it as a logical “1” or high output. If the input voltage is below the low signal voltage, the gate recognizes it as a logical “0” or low output. Other types of circuitry, such as CMOS circuitry, may have different signal voltage levels, but the principle of the voltage signal level for determining a logical state is similar to that of TTL logic.

Processors can be vulnerable to attacks based on out-of-range voltage, such as undervolting or overvolting. These attacks are based on intentionally altering the voltage levels that are supplied to the processor to be outside of its normal operating range and to manipulate its behavior by adjusting, and/or causing instability in the gate voltage threshold, which could potentially lead to unauthorized access to data or allow a hacker to perform other malicious actions. Undervolting involves reducing the voltage supplied to the processor below its recommended operating range. This can cause the processor to malfunction or crash, potentially allowing an attacker to gain access to sensitive data or perform other unauthorized actions. In some cases, undervolting can even cause physical damage to the processor. On the other hand, overvolting involves increasing the voltage supplied to the processor beyond its recommended operating range. This can cause the processor to operate faster than normal, potentially allowing an attacker to bypass security measures or execute code that would not normally be possible. Overvolting can also cause physical damage to the processor.

Additionally, processors can also be vulnerable to attacks based on out-of-range clocking, where an attacker manipulates the clock frequency of a processor to cause it to malfunction or execute unauthorized instructions. This can lead to the exposure of sensitive data, the execution of malicious code, or the enabling of denial-of-service attacks. One type of attack is overclocking, which involves increasing the clock frequency of the processor beyond its recommended operating range. This can cause the processor to operate faster than it was designed to, leading to system instability or damage. An attacker could use this technique to run unauthorized code or bypass security measures that are tied to the processor's clock speed. Conversely, underclocking involves decreasing the clock frequency of the processor below its recommended operating range. This can cause the processor to slow down, which may lead to a denial of service or cause the system to crash. An attacker could use this technique to prevent legitimate users from accessing the system or to disrupt critical services. Clock skew is another type of attack where the clock signal to a processor is manipulated to cause synchronization issues. This can result in incorrect or inconsistent data being processed, leading to security vulnerabilities or system crashes.

To prevent these types of attacks, disclosed embodiments utilize consistency units. The consistency units can perform checks that can detect various anomalies in parameters that could be indicative of an attack. The parameters can include a program counter, memory contents, instruction validity, and so on. The consistency checks can include temporal consistency checks, in which a number of illegal instructions, and/or exceptions are monitored, and in response to detecting an excess of illegal instructions and/or exceptions above a predetermined threshold, the consistency unit can assert an error signal. The error signal can be indicative of a possible environmental attack, such as a voltage and/or clock attack as previously described. In one or more embodiments, the error signal is exposed on a pin of a package that contains an integrated circuit, such as an SoC. This enables external circuitry to monitor the pin and take a mitigation action in response to detecting an asserted signal. The mitigation actions can include halting, shutting down, and/or operating in a safe mode that has reduced functionality. In this way, malicious hardware-based attacks have a reduced likelihood of success.

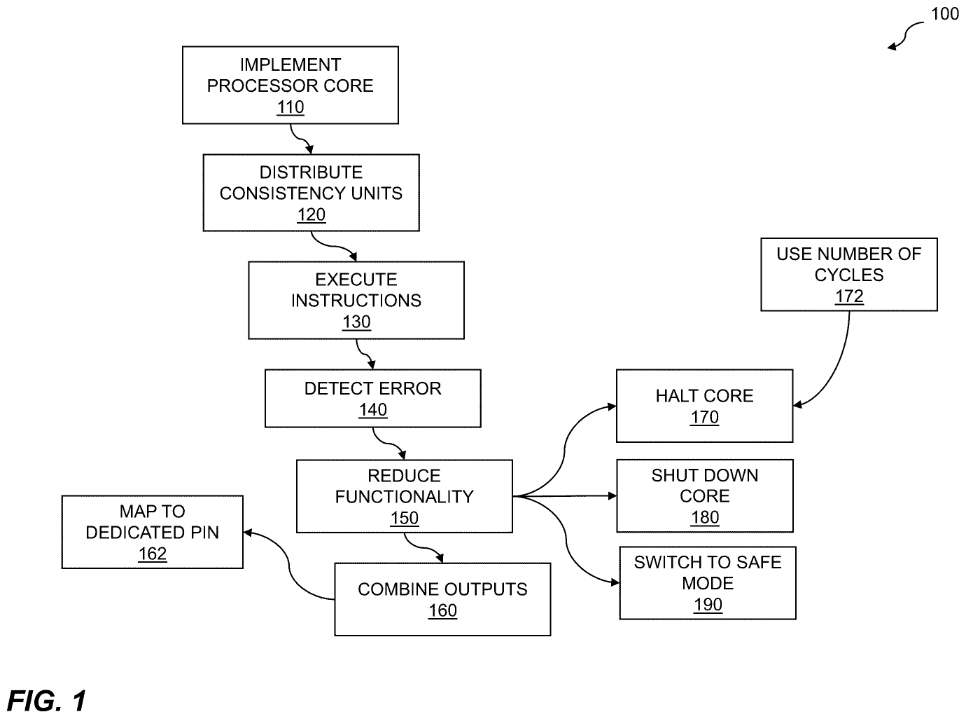

FIG. 1 is a flow diagram for architectural reduction of voltage and clock attack windows. Architectural reduction of voltage and clock attack windows can enhance the security of a processor. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce a functionality of the processor core. The flow 100 includes implementing a processor core 110. The processor core can include a RISC core, such as an ARM™ core, MIPS™ core, RISC-V™ core, or another suitable core. The processor core can include a control unit, an arithmetic logic unit (ALU), a floating point (FP) unit, a graphics processing unit (GPU), input/output (I/O) units, a memory management unit (MMU), various levels of cache (cache hierarchy), registers, and so on. The flow 100 includes distributing consistency units 120. The consistency units can be distributed throughout various areas of a processor core, such as a physical memory protection (PMP) element, memory management unit (MMU), instruction cache, and/or other suitable areas. The flow 100 further includes executing instructions 130. The instructions can include load/store instructions, arithmetic instructions, floating point instructions, branch instructions, logical instructions, shift instructions, and/or other types of instructions. In one or more embodiments, inputs to instructions and/or output results from instructions can be checked by one or more consistency units.

The flow 100 can include detecting an error 140. The error can be detected based on a signal asserted by one or more consistency units. The errors can include, but are not limited to, a program counter error, an invalid instruction error, a load/store error, a data access error, an address exception error, and/or other error types. In response to detecting an error, the flow 100 can include reducing functionality 150. The reducing functionality can include one or more actions taken by the processor, and/or one or more changes in operating mode of the processor. The flow can include halting the core 170. The halting the core can include halting the core within a number of cycles or detecting at least one error. Thus, the flow can include using a number of cycles 172. In embodiments, the number of cycles ranges from 1 to 50. Other ranges of cycles to execute before halting can be used in one or more embodiments. The flow 100 can include performing a shut down of the processor core 180. The shut down can include flushing all pipelines, clearing cache, and/or executing a power-down process. The flow 100 can include switching to safe mode 190.

In embodiments, the reducing the functionality of the processor core further comprises halting the processor core. In embodiments, the halting occurs within a number of cycles of the detecting at least one error. Embodiments can include combining outputs of the one or more consistency units into a single error signal. In embodiments, the single error signal is mapped to a dedicated pin on a package. In embodiments, the reducing the functionality of the processor core further comprises shutting down the processor core. In embodiments, the reducing the functionality of the processor core further comprises switching, by the processor core, to a safe mode. In embodiments, safe mode is a mode of operation in which a program or application runs in a restricted environment with limited access to the computer's hardware resources. In safe mode, the program cannot directly access privileged system resources or execute privileged instructions, for example.

The flow can include combining outputs 160. The combining can include combining outputs from some or all of the consistency units in a processor core or integrated circuit. The flow can include mapping the combined output to a dedicated pin 162. The dedicated pin can be a dedicated pin of a package. The package can include a dual in-line package (DIP), quad flat package (QFP), ball grid array (BGA), and/or another suitable package type. The dedicated pin can be configured to assert a signal when one or more of the consistency units activates, thus providing an indication of a possible environmental attack. This can enable external circuitry to be used for detecting and/or mitigating the environmental attack.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

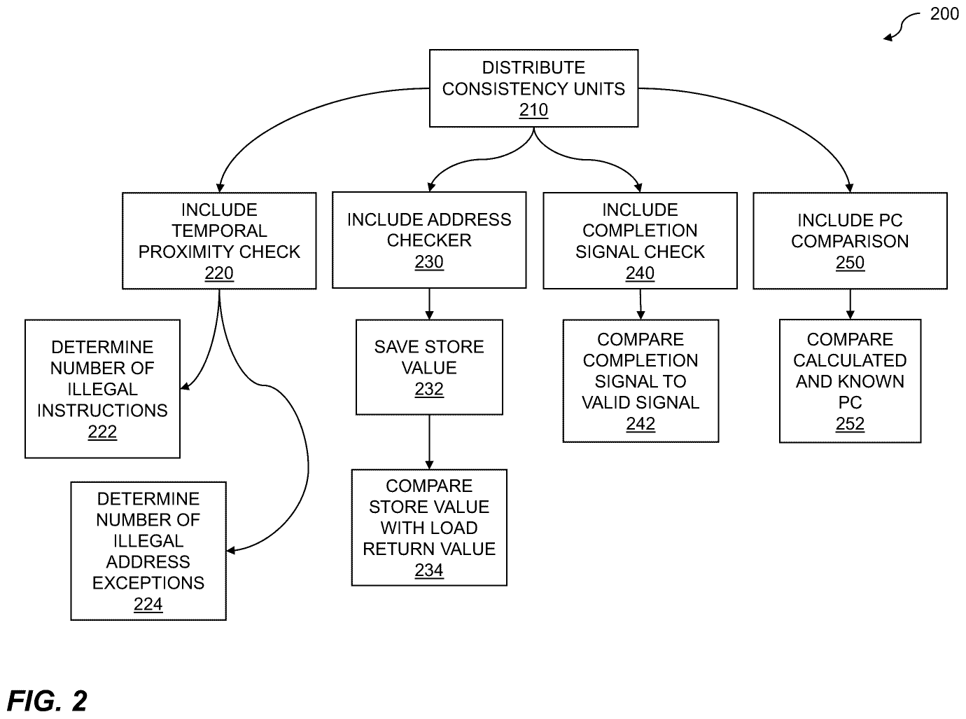

FIG. 2 is a flow diagram for including consistency units. Consistency units can enhance the security of a processor. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce a functionality of the processor core. The flow 200 includes distributing consistency units 210. In embodiments that include multiple cores, each processor core may include one or more consistency units. Consistency units can also be included in global circuit modules within a multicore processor, such as a level 3 cache, platform level interrupt controller (PLIC), and/or other suitable global circuit modules. The flow 200 can include a temporal proximity check 220. The flow 200 can include determining a number of illegal instructions 222. The flow 200 can include determining a number of illegal address exceptions 224. In embodiments, a time window is defined. In embodiments, the time window ranges from 10 microseconds to 50 microseconds. Other time window ranges are possible in disclosed embodiments. In one or more embodiments, a consistency unit checks for a number of illegal instructions and/or illegal address exceptions within the time window. In some embodiments, there is a first time window for illegal instruction counting and a second time window for illegal address exception counting. If an unusually high number of illegal instructions and/or illegal address exceptions are detected within a short time interval, it could be indicative of an attempted attack. In disclosed embodiments, a consistency unit can check for these conditions and assert an error signal in response to detecting elevated numbers of illegal instructions and/or illegal address exceptions. Disclosed embodiments may check for elevated numbers of other types of exceptions as well.

The flow 200 can include an address checker 230. The flow can further include saving a store value 232. The value can be a value stored at a given address. The address can map to main memory, cache memory, a memory-mapped register, and so on. The flow 200 can further include comparing the store value with a load return value 234. In cases where it is expected that the store value and load return value should be equal, a consistency unit can be used to confirm the equality. In response to detection of an inequality, the consistency unit can assert an error signal. The flow 200 can include a completion signal check 240. The flow 200 can further include comparing the completion signal to a valid signal 242. A processor can include multiple instruction processing units, including a dispatch unit and a retire unit.

In a processor pipeline, the dispatch unit is responsible for taking instructions from the instruction queue and issuing them to the appropriate functional units for execution. When a new instruction enters the pipeline, it is first decoded and then placed into an instruction queue. The dispatch unit retrieves instructions from the queue and sends them to the appropriate execution units, which could include the arithmetic logic unit (ALU), the floating-point unit (FPU), or other specialized functional units. The dispatch unit is also responsible for ensuring that the instructions are issued in the correct order and that any data dependencies between instructions are properly handled. This can involve reordering instructions to avoid data hazards, which can occur when an instruction depends on the result of a previous instruction that has not yet been computed. The dispatch unit may include a validity state for each instruction of a set of instructions. At the dispatch unit, some instructions may not yet be valid, based on waiting for software and/or hardware dependencies to resolve. Once resolved, the instruction becomes valid, and can be executed.

The retire unit can be configured to remove the completed instructions from the processor's pipeline and commit their results to the processor's state. In embodiments, the retire unit is located at the end of the pipeline in a commit stage and is responsible for ensuring that the results of completed instructions are committed in the correct order and that any dependent instructions are executed correctly. Once an instruction is retired, its result is written to the processor's register file, and the instruction is removed from the pipeline to make room for new instructions. In disclosed embodiments, a completion signal check function is implemented by checking a validity state of an instruction at the retire unit. The retire unit may include a validity state for each instruction of a set of instructions. In proper operation, each instruction that reaches the retire unit is valid. In embodiments, a consistency unit performs a completion check. The completion check can include determining that the validity state is valid for an instruction at the retire unit. The completion check can further include determining that the validity state is valid for an instruction at the dispatch unit. If either the retire unit or the dispatch unit indicate that an invalid instruction was executed, an error signal is asserted by a consistency unit.

The flow 200 can include a program counter comparison 250. The flow 200 can further include comparing a calculated program counter against a known program counter 252. In a processor, a program counter (PC) is a register that stores the memory address of the next instruction to be executed. The program counter is a fundamental component of a control unit of a processor, and is used to sequence the execution of instructions. The program counter is automatically incremented each time an instruction is fetched from memory, so that it points to the next instruction in sequence. The program counter is typically initialized with the memory address of the first instruction to be executed when the processor starts up. During the execution of a program, the program counter is constantly updated to point to the next instruction in sequence. Branch instructions, interrupt handlers, and exception handlers can cause the next instruction to be a non-sequential instruction, and the program counter can be updated accordingly to reflect a new instruction stream to start executing. The program counter allows the processor to fetch, decode, and execute instructions in a predetermined order, as specified by the program being executed. The program counter is an essential component of the fetch-decode-execute cycle that is at the heart of processor operation. By keeping track of the memory address of the next instruction to be executed, a consistency unit can verify that the program counter contains the expected value, ensuring that the processor is executing the correct sequence of instructions.

In embodiments, the one or more consistency units include a temporal proximity check function. Embodiments can further include determining if a number of illegal instruction exceptions within a first time window exceeds a first threshold value. In embodiments, the first threshold value is programmable. In embodiments, the first time window is programmable. In embodiments, the processor core is operating in a privileged mode. In one or more embodiments, the privileged mode of operation allows the operating system and device drivers to access hardware resources directly. In privileged mode, programs can execute privileged instructions and access all system resources. However, because privileged mode has unrestricted access to the system, any errors or bugs can have serious consequences, including system crashes and data corruption. Thus, disclosed embodiments utilize time windows to monitor a predetermined number of illegal instructions and/or illegal address exceptions. Embodiments can further include determining if a number of illegal address exceptions within a second time window exceeds a second threshold value. In embodiments, the second threshold value is programmable. In embodiments, the second time window is programmable.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

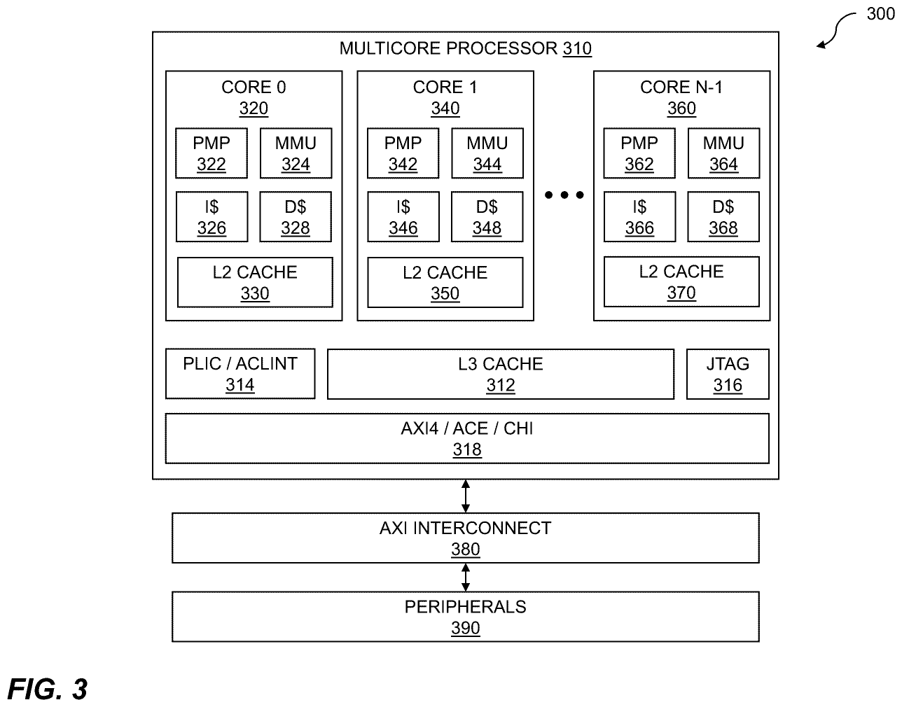

FIG. 3 is a block diagram illustrating a multicore processor. A multicore processor uses disclosed techniques to enhance the security of processors. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce the functionality of the processor core. In embodiments, the multicore processor can be a RISC-V™ processor, ARM™ processor, MIPS™ processor, or some other suitable processor type. The processor can include a multi-core processor, where two or more processor cores can be included. The processor, such as a RISC-V™ processor, can include a variety of elements. The elements can include processor cores, one or more caches, memory protection and management units (MMUs), local storage, and so on. The elements of the multicore processor can further include one or more of a private cache, a test interface such as a joint test action group (JTAG) test interface, one or more interfaces to a network such as a network-on-chip, shared memory, peripherals, and the like. The multicore processor is enabled by processor and network-on-chip coherency management. A plurality of processor cores is accessed. Each processor of the plurality of processor cores accesses a common memory through a coherent network-on-chip, and the coherent network-on-chip comprises a global coherency. A local cache is coupled to a grouping of two or more processor cores of the plurality of processor cores.

The block diagram 300 can include a multicore processor 310. The multicore processor can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In embodiments, each core, including cores 0 through core N-1, can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses with caches, the share memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N-1. In addition to the level 1 instruction and data caches, each core can include a level 2 (L2) cache. The level 2 caches can include an L2 cache 330 associated with core 0; an L2 cache 350 associated with core 1; and an L2 cache 370 associated with core N-1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 314. The platform level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces including an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

Multicore processor 310 can include multiple consistency units (not shown), which can be spread throughout core 0 320, core 1 340, and so on. Additionally, multiple consistency units can be spread throughout the entire multicore processor 310. For example, core 0 320 can include five consistency units. However, in practice there can be more or fewer consistency units. In one or more embodiments, global circuit modules, such as the platform level interrupt controller (PLIC) 314, level 3 (L3) cache 312, and/or joint test action group (JTAG) element 316, can each include one or more consistency units. The consistency units can be used to check for proper operation at various locations within a multicore processor, or the cores themselves within a multicore processor, and they can assert an error signal in response to detecting a potentially malicious condition.

In embodiments, at least one of the one or more consistency units operate in a more robust circuit environment than the processor core. In embodiments, the more robust circuit environment includes a faster clock speed than the processor core. In embodiments, the more robust circuit environment includes a lower voltage than the processor core. In embodiments, the more robust circuit environment includes a higher voltage than the processor core.

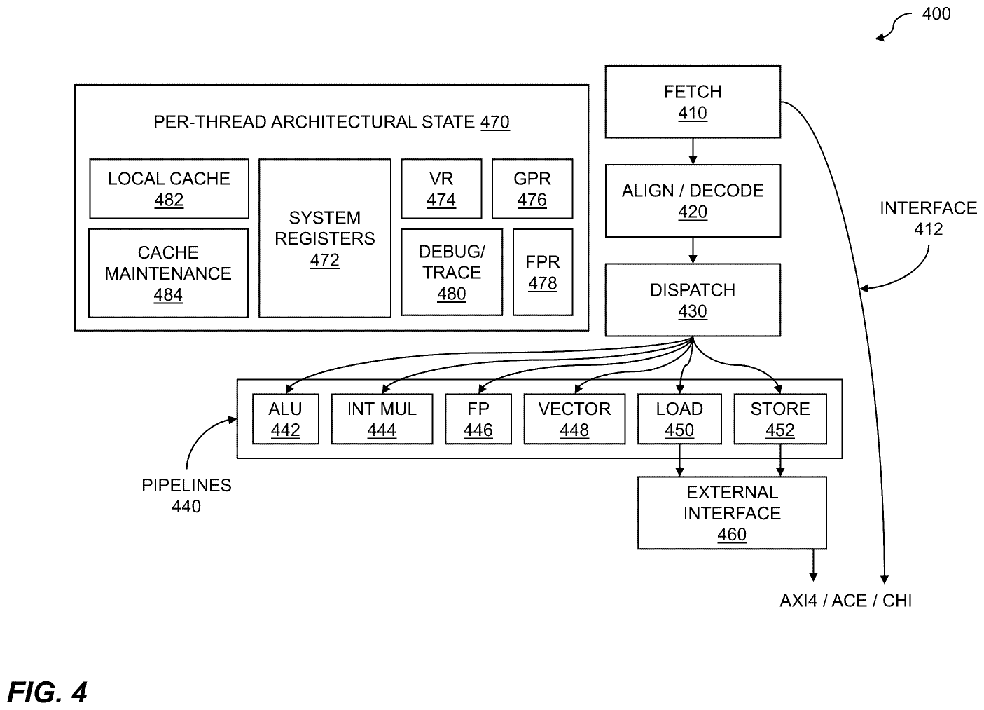

FIG. 4 shows a block diagram of a pipeline. The pipeline can comprise a processor core pipeline. The processor core pipeline can be used to enhance the security of processors. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce a functionality of the processor core. The blocks within the block diagram can be configurable in order to provide varying processing levels. The varying processing levels can be based on processing speed, bit lengths, and so on. The block diagram 400 can include a fetch block 410. The prefetching logic of disclosed embodiments may be performed by the fetch block 410. The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The block diagram 400 can include a dispatch block 430. The dispatch block can receive decoded instruction packets from the align and decode block. The decode instruction packets can be used to control a pipeline 440, where the pipeline can include an in-order pipeline, an out-of-order (OOO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OOO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474, general purpose registers (GPR) 476, and floating-point registers 478. These registers can be used for vector operations, general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

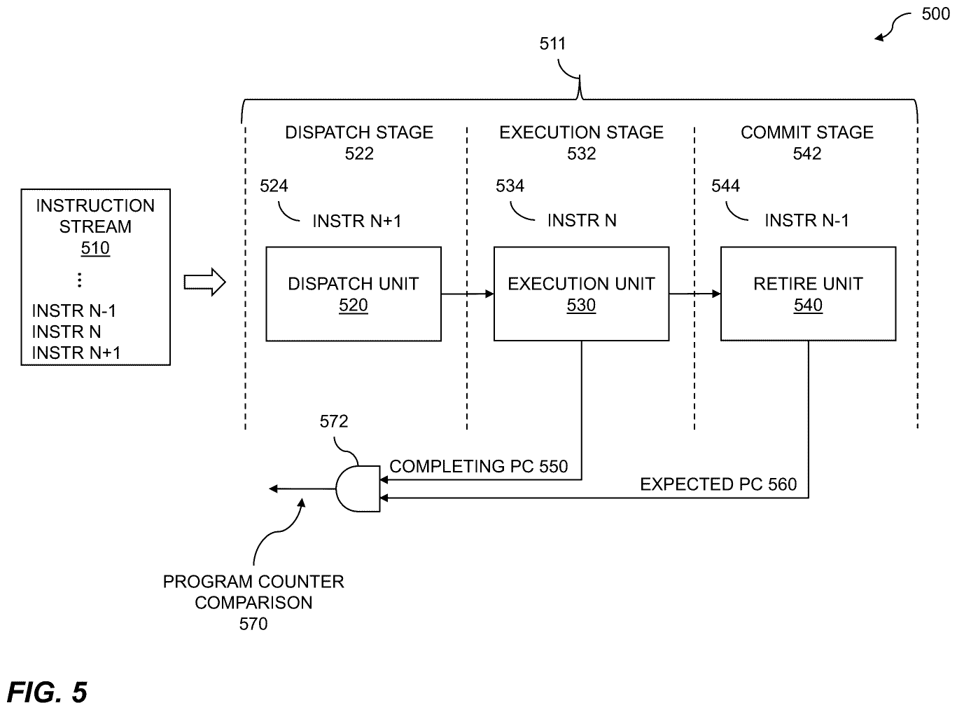

FIG. 5 is a block diagram for a program counter comparison function. The program counter comparison function can be used to enhance the security of a processor. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce a functionality of the processor core. The block diagram 500 includes an instruction stream 510, which includes a plurality of instructions, indicated as instruction N-1, instruction N, and instruction N+1. Instruction pipeline 511 includes a dispatch stage 522, an execution stage 532, and a commit stage 542. The dispatch stage 522 includes a dispatch unit 520. The execution stage 532 includes an execution unit 530. The commit stage 542 includes a retire unit 540. In the instruction pipeline 511, the execution stage is processing instruction N at 534, while the dispatch stage is processing instruction N+1 at 524, and the commit stage is processing instruction N-1 at 544. In the instruction stream 510, each instruction in the sequence of instructions has a known program counter (PC) relationship. As an example, with 32-bit instructions, the program counter can index by four bytes on sequential instructions. Thus, if instruction N-1 has a program counter value of 0x10000004, then instruction N will have a program counter value of 0x10000008, in the case of sequential instructions. The aforementioned program counter relationship can be checked by a consistency unit in disclosed embodiments. In one or more embodiments, the retire unit 540 can compute an expected program counter 560. A consistency unit 572 can compare a completing program counter 550 with the expected program counter. In response to the completing program counter 550 not matching the expected program counter 560, the consistency unit 572 can assert a program counter comparison signal 570 to indicate improper operation due to a possible environmental attack. In the aforementioned example, the retire unit 540, retiring instruction N-1 corresponding to a program counter value of 0x10000004 can cause the retire unit 540 to generate a value of expected program counter 560 of 0x10000008. Accordingly, the signal 570 can be combined, and/or routed to an external pin of a package in order to enable external circuitry to provide additional protection and/or mitigation, such as shutting off power, disconnecting interfaces, and so on. In embodiments, the one or more consistency units include a program counter comparison function. In embodiments, the program counter comparison function comprises comparing a completing program counter value with an expected program counter value.

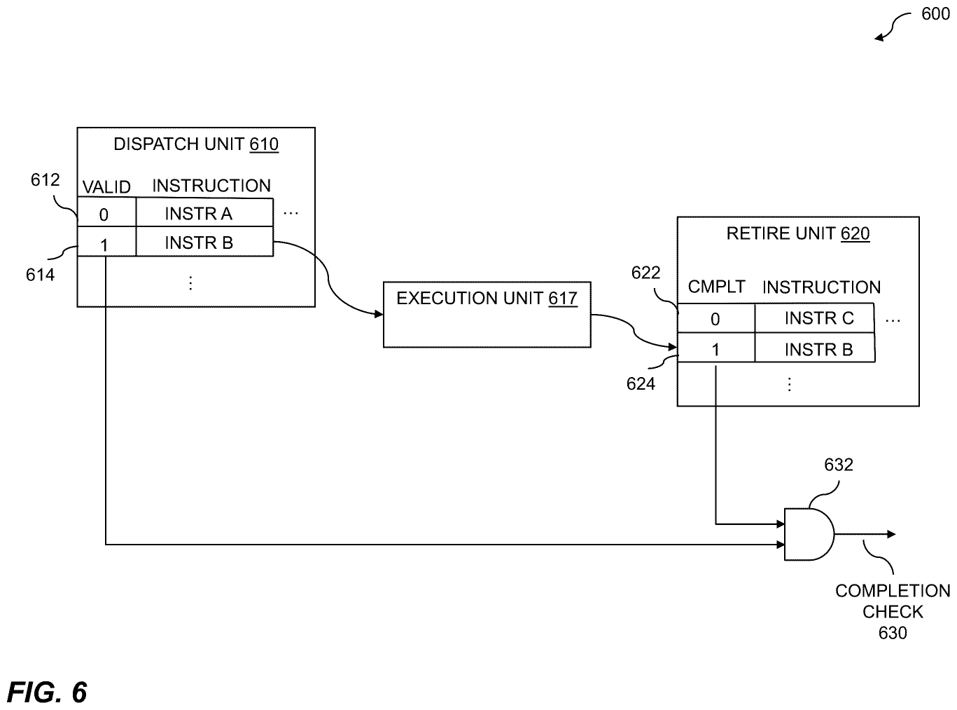

FIG. 6 is a block diagram for a completion signal check function. The completion signal check function can be used to enhance the security of a processor. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce a functionality of the processor core. The block diagram 600 includes a dispatch unit 610. The dispatch unit 610 includes an instruction table comprising row 612 and row 614. Row 612 corresponds to instruction A, and row 614 corresponds to instruction B. The valid bit for instruction A, as shown in row 612, is 0, while the valid bit for instruction B, as shown in row 614, is 1. A valid bit set to a value of 1 indicates that the instruction is valid and ready to be executed. A valid bit set to a value of 0 indicates that the instruction is not valid. In embodiments, an instruction can be an instruction that has dependencies that are not yet resolved (e.g., control and/or data hazards). Once the dependencies are resolved, the valid bit is set to 1, indicating the instruction is ready to be executed. Once valid, the instruction can proceed to the execution unit 617. Once executed, the instruction can proceed to the retire unit 620. In embodiments, the retire unit includes an instruction table comprising row 622 and row 624. Row 622 corresponds to instruction C, and row 624 corresponds to instruction B. The completion bit for instruction C as shown in row 622, is 0, while the completion bit for instruction B, as shown in row 624, is 1. A completion bit set to a value of 1 indicates that the instruction has completed execution. A completion bit set to a value of 0 indicates that the instruction has not yet completed. A consistency unit 632 asserts a signal corresponding to completion check 630 by comparing the completion status and valid status of an instruction in the retire unit 620, and asserting an error signal if an instruction indicated as complete in retire unit 620 is indicated as not valid in the dispatch unit 610.

In one or more embodiments, the instructions can be executed out-of-order (OOO). In a pipelined processor, the instructions are divided into smaller stages, and each stage is executed in parallel by different hardware units. This allows multiple instructions to be processed simultaneously, which increases the overall performance of the processor. However, when an instruction depends on the result of a previous instruction that has not yet been completed, a pipeline stall occurs. To mitigate pipeline stalls, OOO execution can be used to enable the pipeline to continue executing instructions that are not dependent on the stalled instruction, while the stalled instruction is completed. In embodiments, a compiler may generate machine instructions that are out of order with respect to high-level source code that is input to the compiler, freeing a programmer from having to be concerned with low-level optimizations based on a pipelined architecture. Disclosed embodiments support techniques for enhancing security of a processor that are compatible with OOO execution, thereby providing improved security along with improved performance. In embodiments, the one or more consistency units include a completion signal check function. In embodiments, the completion signal check function comprises comparing a completion signal associated with an instruction to a valid signal associated with the instruction in a dispatch unit.

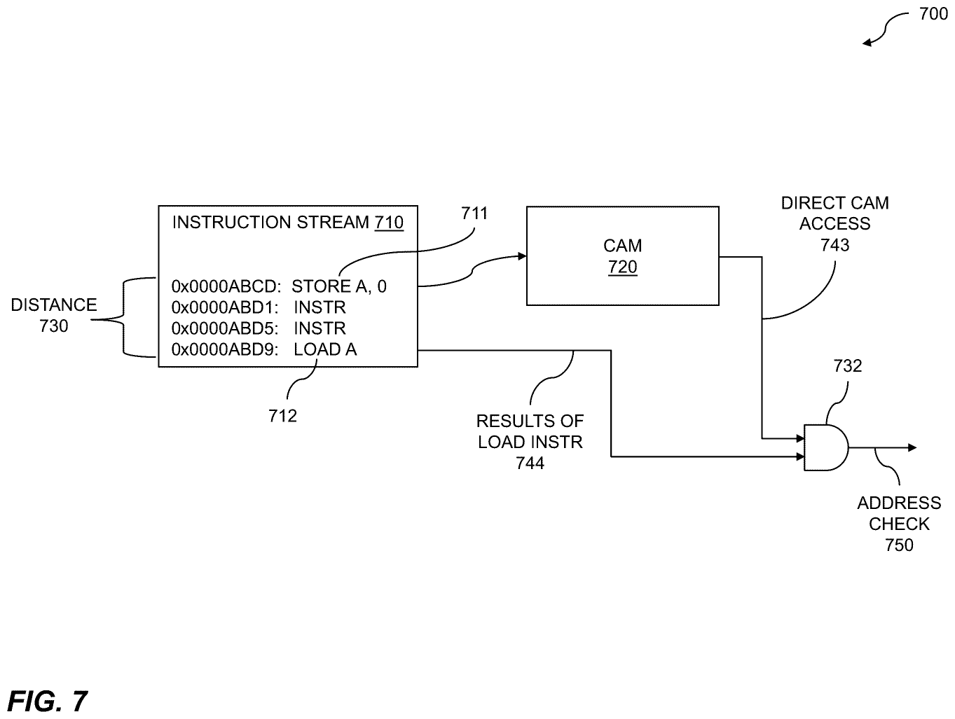

FIG. 7 is a block diagram for an address check function. An address check function can be used to enhance the security of processors. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce a functionality of the processor core. In the block diagram 700, an instruction stream 710 comprises a plurality of instructions that include a store instruction 711 and a load instruction 712. Instruction 711 and instruction 712 are separated by a distance 730, measured in instructions. As shown in instruction stream 710, instruction 712 is three instructions away from instruction 711. Thus, in block diagram 700, the distance 730 has a value of three. Instruction 711 is a store instruction, that stores data “A” in a memory, such as a content addressable memory (CAM) 720. Content-addressable memory (CAM) is a type of computer memory that allows data to be accessed based on its content rather than its memory address. In other words, it is a memory device that stores data and allows the system to search for a specific data item based on its content, rather than requiring the system to know the address where the data is stored. CAM is used in applications where rapid searches of data are necessary, including processing applications. A content-addressable memory typically includes a memory array and a comparison circuit. The memory array stores data items, while the comparison circuit compares a search data item with the data items stored in the memory array. When a match is found, the address of the matching data item is returned. CAM can be implemented using various technologies, such as static RAM, dynamic RAM, or associative memory.

In execution of the instruction sequence in instruction stream 710, first instruction 711 is executed, which is a store instruction, storing data in CAM 720. There can be some intervening instructions, followed by load instruction 712. Load instruction 712 reads the value from the CAM 720. In one or more embodiments, a consistency unit 732 compares the results of the load instruction 744 with the contents of CAM 720 via direct CAM access 743. The consistency unit 732 outputs an address check 750, which is a signal that when asserted, can indicate that the contents did not match, and indicates a potential environmental attack scenario. The asserted address check 750 can be combined with other consistency check outputs and/or can be mapped to a pin of a package to enable external circuitry to monitor the processor for an error condition. If an error condition is found, mitigative steps such as shutting down the processor and/or disconnecting interfaces, including I/O pins, network connections, serial connections, and so on, can be taken. In embodiments, the consistency check is performed when a store instruction and its corresponding load instruction are within a predetermined distance. Note that while a CAM is used as the storage in the example of FIG. 7, disclosed embodiments can perform address check functions on other types of memory, including, but not limited to dynamic random-access memory (DRAM) and static random-access memory (SRAM).

In embodiments, the one or more consistency units include an address check function. In embodiments, the address check function further comprises saving a store value associated with a store instruction to a memory address. Embodiments can further include comparing the store value with a load return value from a load instruction associated with the memory address. In embodiments, the store instruction and the load instruction are separated by a number of instructions below a threshold value, wherein the threshold value is programmable. In embodiments, the saving and comparing are accomplished with a Content Addressable Memory (CAM).

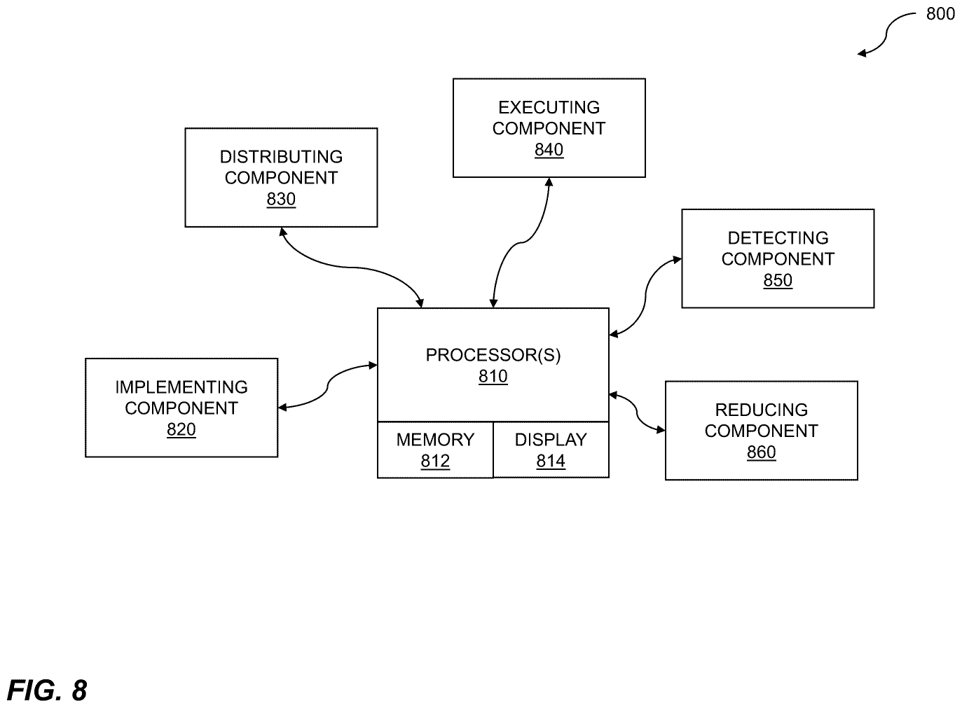

FIG. 8 is a system diagram for architectural reduction of voltage and clock attack windows. The architectural reduction of voltage and clock attack windows can enhance the security of processors. Multiple consistency units are distributed within a processor core. Instructions are executed in an architecturally defined mode. The architecturally defined mode can be based on an instruction set architecture (ISA). In response to detecting an error in at least one consistency unit, disclosed embodiments reduce the functionality of the processor core. The system 800 can include instructions and/or functions for design and implementation of integrated circuits that support architectural reduction of voltage and clock attack windows. The system 800 can include instructions and/or functions for generation and/or manipulation of design data such as hardware description language (HDL) constructs for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 800 can include one or more processors 810. The processors can include standalone processors within integrated circuits or chips, processor cores in FPGAs or ASICs, and so on. The one or more processors 810 are coupled to a memory 812 which stores operations. The memory can include one or more of local memory, cache memory, system memory, etc. The system 800 can further include a display 814 coupled to the one or more processors 810. The display 814 can be used for displaying data, instructions, operations, and the like. The operations can include instructions and functions for implementation of integrated circuits, including processor cores. In embodiments, the processor cores can include RISC-V™ processor cores. The system 800 can include an implementing component 820. The implementing component 820 can include functions and instructions for processing design data for implementing a processor core. The processor core can include a local cache hierarchy, prefetch logic, and a prefetch table, where the processor core is coupled to an external memory system. The processor core can include FPGAs, ASICs, etc. In embodiments, the processor core can include a RISC-V™ processor core. The processor core can support consistency units distributed throughout one or more cores, and/or global circuit modules of an integrated circuit, to support architectural reduction of voltage and clock attack windows, as previously described.

The system 800 can include a distributing component 830. The distributing component 830 can include functions and instructions for processing design data for distributing consistency units throughout an integrated circuit. The consistency units can be coupled to various modules or functional blocks within an integrated circuit, including, but not limited to, arithmetic logic units (ALUs), floating point (FP) units, memory management units (MMUs), I/O controllers, DMA controllers, digital signal processing (DSP) units, interrupt controllers, and so on. The consistency units can be strategically placed in order to detect possible environmental attacks including an architectural reduction of voltage and/or a clock attack.

The system can include an executing component 840. The executing component 840 can include functions and instructions for processing design data for executing instructions, by the processor core, in an architecturally defined mode. The architecturally defined mode can be based on an instruction set architecture containing known instructions, opcodes, mnemonics, and/or other data. The instruction set architecture can include a RISC-V™ instruction set, an ARM™ instruction set, a MIPS™ instruction set, an x86™ instruction set, and so on.

The system can include a detecting component 850. The detecting component 850 can include functions and instructions for processing design data for detecting at least one error in the one or more consistency units that were distributed. The errors can include program counter errors, data read/write errors, invalid instruction execution errors, a number of illegal instructions and/or illegal address exceptions exceeding a predetermined threshold, and so on.

The system can include a reducing component 860. The reducing component 860 can include functions and instructions for processing design data for reducing a functionality of the processor core upon detection of the at least one error in the one or more consistency units. In embodiments, the reducing functionality can be performed by the processor. The reducing of functionality can include executing in a safe mode, where the safe mode limits instructions, and/or operands that can be used. The reducing functionality can include halting the processor, shutting down the processor, flushing pipelines, flushing cache, disabling I/O interfaces, and so on.

As can now be appreciated, disclosed embodiments provide improvements in processor security. By distributing consistency units throughout an integrated circuit, unpredictable results stemming from an environmental attack can be detected, and mitigation steps can be performed. The environmental attacks can include operating voltage spikes and/or dips, providing a supply voltage outside of a recommended range, varying an input clock, applying a strong electromagnetic field to an integrated circuit, and so on. While it may not be possible to detect every possible malfunction that can occur under adverse operating conditions, disclosed embodiments provide an additional level of security by distributing one or more consistency units within an integrated circuit and reducing a functionality of the processor upon detection of the at least one error in the one or more consistency units.

The system 800 can include a computer program product embodied in a non-transitory computer readable medium for instruction execution, the computer program product comprising code which causes one or more processors to generate semiconductor logic for: implementing a processor core, wherein the processor core includes semiconductor logic and one or more consistency units; distributing, within the processor core, the one or more consistency units; executing instructions, by the processor core, in an architecturally defined mode; detecting at least one error in the one or more consistency units that were distributed; and reducing a functionality of the processor core upon detection of the at least one error in the one or more consistency units.

The system 800 can include a computer program product embodied in a non-transitory computer readable medium for instruction execution, the computer program product comprising code which causes one or more processors to perform operations of: implementing a processor core, wherein the processor core includes semiconductor logic and one or more consistency units; distributing, within the processor core, the one or more consistency units; executing instructions, by the processor core, in an architecturally defined mode; detecting at least one error in the one or more consistency units that were distributed; and reducing a functionality of the processor core upon detection of the at least one error in the one or more consistency units.

The system 800 can include a computer system for instruction execution comprising: a memory which stores instructions; one or more processors attached to the memory wherein the one or more processors, when executing the instructions which are stored, are configured to: implement a processor core, wherein the processor core includes semiconductor logic and one or more consistency units; distribute, within the processor core, the one or more consistency units; execute instructions, by the processor core, in an architecturally defined mode; detect at least one error in the one or more consistency units that were distributed; and reduce a functionality of the processor core upon detection of the at least one error in the one or more consistency units.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products, processor-implemented methods, or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for enhancing security comprising:
implementing a processor core, wherein the processor core includes semiconductor logic and one or more consistency units;
distributing, within the processor core, the one or more consistency units;
executing instructions, by the processor core, in an architecturally defined mode;
detecting at least one error in the one or more consistency units that were distributed; and
reducing a functionality of the processor core upon detection of the at least one error in the one or more consistency units.

2. The method of claim 1 wherein the one or more consistency units include a program counter comparison function.

3. The method of claim 2 wherein the program counter comparison function comprises comparing a completing program counter value with an expected program counter value.

4. The method of claim 1 wherein the one or more consistency units include a completion signal check function.

5. The method of claim 4 wherein the completion signal check function comprises comparing a completion signal associated with an instruction to a valid signal associated with the instruction in a dispatch unit.

6. The method of claim 1 wherein the one or more consistency units include an address check function.

7. The method of claim 6 wherein the address check function further comprises saving a store value associated with a store instruction to a memory address.

8. The method of claim 7 further comprising comparing the store value with a load return value from a load instruction associated with the memory address.

9. The method of claim 8 wherein the store instruction and the load instruction are separated by a number of instructions below a threshold value, and wherein the threshold value is programmable.

10. The method of claim 1 wherein the one or more consistency units include a temporal proximity check function.

11. The method of claim 10 further comprising determining if a number of illegal instruction exceptions within a first time window exceeds a first threshold value.

12. The method of claim 11 wherein the first threshold value is programmable.

13. The method of claim 11 wherein the first time window is programmable.

14. The method of claim 10 further comprising determining if a number of illegal address exceptions within a second time window exceeds a second threshold value.

15. The method of claim 14 wherein the second threshold value is programmable.

16. The method of claim 14 wherein the second time window is programmable.

17. The method of claim 1 wherein the reducing the functionality of the processor core further comprises halting the processor core.

18. The method of claim 17 wherein the halting occurs within a number of cycles of the detecting at least one error.

19. The method of claim 1 further comprising combining outputs of the one or more consistency units into a single error signal.

20. The method of claim 1 wherein the reducing the functionality of the processor core further comprises shutting down the processor core.

21. The method of claim 1 wherein the reducing the functionality of the processor core further comprises switching, by the processor core, to a safe mode.

22. The method of claim 1 wherein at least one of the one or more consistency units operate in a more robust circuit environment than the processor core.

23. The method of claim 22 wherein the more robust circuit environment includes a faster clock speed than the processor core.

24. The method of claim 22 wherein the more robust circuit environment includes a lower voltage than the processor core.

25. The method of claim 22 wherein the more robust circuit environment includes a higher voltage than the processor core.

26. A computer program product embodied in a non-transitory computer readable medium for instruction execution, the computer program product comprising code which causes one or more processors to generate semiconductor logic for:
implementing a processor core, wherein the processor core includes semiconductor logic and one or more consistency units;
distributing, within the processor core, the one or more consistency units;
executing instructions, by the processor core, in an architecturally defined mode;
detecting at least one error in the one or more consistency units that were distributed; and
reducing a functionality of the processor core upon detection of the at least one error in the one or more consistency units.

27. A computer system for instruction execution comprising:
a memory which stores instructions;
one or more processors coupled to the memory wherein the one or more processors, when executing the instructions which are stored, are configured to:
implement a processor core, wherein the processor core includes semiconductor logic and one or more consistency units;
distribute, within the processor core, the one or more consistency units;
execute instructions, by the processor core, in an architecturally defined mode;
detect at least one error in the one or more consistency units that were distributed; and
reduce a functionality of the processor core upon detection of the at least one error in the one or more consistency units.
